(19) United States
(12) Patent Application Publication
(10) Pub. No.: US 2011/0197974 A1
(43) Pub. Date: Aug. 18, 2011

(54) Draining Apparatus

(76) Inventors: Robert Menear, West Midlands (GB); Christopher Corbett, West Midlands (GB); Allan Price, West Midland (GB)

(21) Appl. No.: 13/055,529

(22) PCT Filed: Jul. 23, 2009
(86) PCT No.: PCT/GB2009/050912

§ 371 Date: Apr. 8, 2011

(30) Foreign Application Priority Data
Jul. 24, 2008 (GB) 0813576.6
Sep. 30, 2008 (GB) 0817847.7
Jul. 1, 2009 (GB) 0911346.5

(51) Int. Cl. F16T 1/20

(52) U.S. Cl. 137/192

(57) ABSTRACT

A draining apparatus for use in discharging water from a cistern which is arranged for dual flush operation. The apparatus includes an inlet member (2), buoyancy altering means connected to the inlet member and an outlet (4) fluidly connected to an inlet of the inlet member by an adjustable conduit (5). The buoyancy altering means is operable to decrease the buoyancy of the inlet member thereby submerging, in use, at least a portion of the inlet and discharging water from the cistern. In one embodiment, the buoyancy altering means includes a buoyancy member (3) releasably latched to the inlet member for movement therewith. In another embodiment, the buoyancy altering means includes a buoyancy chamber with a valve operable to selectively release or retain air within the chamber. In a yet further embodiment, the buoyancy altering means includes flow altering vanes at or adjacent the inlet arranged to alter, in use, the direction and/or flow rate of the water passing through the inlet thereby to reduce the effective buoyancy of the inlet member.

This invention relates generally to draining apparatus and more particularly, although not exclusively, to draining apparatus for emptying, for example flushing, a cistern to clean the contents of a toilet pan.

Apparatus for this purpose generally include two types of flushing mechanism, namely a first type in which a valve is operated by a push button and a second in which a syphon is operated by a lever. The main advantage of the valve mechanism is that end users tend to prefer the push button means of actuation over the lever-type arrangement. However, valve mechanisms include a movable seal which is prone to leakage, whereas syphon mechanisms do not include such a movable seal. Several attempts have been made in the past to create a syphon which is operated by a push button. One such attempt is disclosed in EP1640516, which provides a combined syphon and cistern, which precludes the possibility of installing the mechanism into an existing cistern. Additionally, it requires a higher head of water to achieve a flow rate which passes the industry standards. In some jurisdictions, for example the UK, there is a significant market for concealed cistern fitted into furniture, e.g. which has a height of 800 mm from the ground. The latter example has a minimum height of 1200 mm.

It is therefore a first non-exclusive object of the invention to provide a draining apparatus which does not leak water yet is operated by a relatively soft touch push button and can be fitted into a wide range of cisterns in existing environments.

Moreover, GB2338723 discloses a typical syphon assembly having an inverted U shaped duct with an up leg and a down leg, wherein the up leg has a chamber with a movable piston at its inlet. The piston includes a flexible diaphragm which acts as a one way valve, wherein upward movement of the piston initiates a syphonic flushing action and the diaphragm flexes to allow passage of the contents of the cistern until a predetermined level is reached. It will be appreciated by those skilled in the art that, depending on the quality of the water used in the toilet, the diaphragm may become worn or damaged in use.

Another example of such an apparatus is shown in EP1360380, which discloses an assembly that includes a flow directing element which, when it is pushed downward by a user, directs water from the cistern into the inlet of a sliding conduct, thus initiating a syphoning effect. The telescopically slidable nature of the sliding conduct provides the guide means for the movement of the flow directing element. The flow directing element is also kept above the water level in normal conditions by a float. Whilst this arrangement precludes the need for a piston or diaphragm, the buoyancy of the floating means requires significant pushing force to overcome. Also, the internal guide means limits the amount of travel that is possible within the available space in the cistern.

GB805876 discloses another draining apparatus in which the drain pipe is provided with a constriction which generates a suction force of sufficient magnitude to counter the buoyancy of the light-weight inlet bell and to pull it downwards.

It is a therefore a further non-exclusive object of the invention to provide a draining apparatus which is simpler and/or more effective and/or which mitigates the issues associated with the prior art.

One aspect of the invention provides a draining apparatus for discharging water from a cistern, the apparatus comprising an inlet member, buoyancy altering means connected to the inlet member and an outlet fluidly connected to an inlet of the inlet member by an adjustable conduit, wherein the buoyancy altering means is operable to decrease the buoyancy of the inlet member thereby submerging, in use, at least a portion of the inlet and discharging water from the cistern.

The use of buoyancy altering means to selectively submerge the inlet member precludes the need to force the inlet member to the flushing position.

The buoyancy altering means may comprise a buoyancy member, for example a float, which may be connected or secured to or held with, e.g. releasably connected or secured to or held with, the inlet member. Preferably, the apparatus or buoyancy altering means includes a holding means or connector means, for example a catch means, latch means or lock means, which is operable to connect or secure the buoyancy member to or hold the buoyancy member with the inlet member and/or to disconnect or release the buoyancy member therefrom. The apparatus or holding means or connector means may further comprise a lifting means or mechanism or lever, for example which is configured to raise the inlet member relative to the buoyancy member, e.g. as the buoyancy member rises in use. More preferably, the apparatus comprises a flush actuation means such as an actuating bellows configured to operate the holding means or connector means. The actuation means may be connected to an actuator, e.g. a push button or lever, by a pipe or tube. The holding or connector means is preferably biased, e.g. under the influence of or by gravity, toward the connected or latched state or position or condition.

Additionally or alternatively, the buoyancy altering means may comprise a buoyancy control means. The buoyancy control means or the buoyancy member may include a buoyancy chamber, for example connected to the inlet member, and/or a valve which is preferably operable between an open condition for releasing air from the chamber and/or a closed condition for retaining air within the chamber. Additionally or alternatively, the buoyancy altering means may comprise vortex inducing means and/or flow altering vanes at or adjacent the inlet, which may be arranged to alter, in use, the flow of water, e.g. the direction and/or flow rate of the water, passing through the inlet thereby to reduce the effective buoyancy of the inlet member.

The inlet member and/or the buoyancy member is or are preferably connected, e.g. slideably connected, to a base or frame, e.g. a tubular member such as an stand or upstand, and/or movable or slideable between a pre-flush position or condition, e.g. a raised position or condition, and a flush position or condition, e.g. a lowered position. For example, the buoyancy member may slideably receive a portion of the base or frame. Where the apparatus or holding means or connector means comprises a lifting lever, the lever may include a first end which slideably engages a slot in the base or frame, e.g. in an outer surface of the upstand, and may include a second end which engages the inlet member, e.g. the holding means or connector means, and may be pivotably connected to the buoyancy member intermediate the two ends, for example such that movement of the buoyancy member along the base or frame raises the inlet member relative to the buoyancy member. The inlet member may include a carriage which is preferably slideably connected to, e.g. slideably receivable within, the base or frame. The apparatus may comprise stop means, e.g. for limiting the movement of the inlet member, for example relative to the base or frame. The base or frame may advantageously comprise guide means, e.g. mounted externally of the adjustable conduit, for guiding movement of the inlet member as it is submerged and/or as it moves between the pre-flush position or condition and the flush position or condition. This arrangement is believed to mitigate the aforementioned problems associated with the internal guide means.

The carriage may comprise an abutment, e.g. an adjustable abutment, which may abuts the base or frame when the inlet member is in the flush position or condition. The adjustable abutment may comprise a threaded shaft, e.g. which extends from a lower portion of the carriage and/or the threaded shaft may be connected or connectable to an adjustment handle or tool for rotation therewith. Thus, a user may adjust the flush position or condition by adjusting the adjustable abutment, which can be done by simply rotating the handle or tool.

Additionally, the apparatus may be configured to provide partial flush and/or dual flush functionality. For example, the inlet member may also be movable to a partial flush position or condition. The stop means may comprise a movable stop means, which may be movable between a retracted position or condition and a deployed position or condition. The stop means may be configured to stop the inlet member at an intermediate position or condition between the pre-flush position or condition and the flush position or condition, e.g. when it is in the deployed position or condition. For example, the stop means may comprise a stop, latch or tab which may be connected, secured or fixed to a rotatable shaft, e.g. to an end thereof, and/or which may be rotatable between the retracted position or condition, e.g. wherein the inlet member is free to move between the pre-flush position or condition and the flush position or condition, and the deployed position or condition, e.g. wherein the inlet member is prevented from moving to the flush position or condition.

The stop means may advantageously be at least partially located within the base or frame, e.g. to cooperate with the carriage. The apparatus may comprise a partial flush actuation means such as an actuating bellows configured to operate the stop means, for example between the retracted and deployed positions or conditions, e.g. by actuating a lever. The partial flush actuation means may be connected to an actuator, e.g. a push button or lever, by a pipe or tube. For example, the actuation means may be configured to move a first end of a lever which is connected at its second end to a pivot member extending from and/or connected to the shaft, e.g. thereby rotating the stop means between the retracted and deployed positions or conditions. The pivot member preferably includes a projection, e.g. on the underside thereof, which may be configured to cooperate with a recess of or on or in the base or frame, e.g. to retain the pivot member when the stop means is in the deployed condition. The apparatus may be configured such that the projection engages the recess automatically, e.g. under the influence of or by gravity, when the pivot member is caused to rotate the stop means to the deployed condition. Advantageously, the inlet member or the carriage may be configured to move or force or urge the projection and recess out of engagement when the inlet member is moved to the pre-flush position or condition. The lever may be biased, e.g. under the influence of gravity, to move the stop means toward the retracted condition. The partial flush actuation means may be configured to cause the holding means or connector means to disconnect or release the buoyancy member from the inlet member when it operates the stop means from the retracted position or condition to the deployed position or condition.

The partial flush position or condition may be adjustable, for example by adjustment means which may comprise a step-wise adjustment means. For example, the shaft may comprise a plurality of recesses or notches, e.g. along its length, with which a latch of the pivot member may cooperate. The pivot member latch may be resiliently biased toward an engaged position or condition in which a portion of the pivot member latch engages one of the recesses or notches of the shaft. The adjustment means may be adjustable by actuating, in use, the latch to move it to a disengaged position or condition, moving the shaft relative to the pivot member and releasing the latch such that it returns to its engaged position or condition thereby engaging a different one of the plurality of recesses or notches.

The inlet member may be releasably connected or secured to the carriage, for example by a second holding means or connector means, for example a second catch means, latch means or lock means. The second holding means or connector means may comprise one or more movable latches on one of the inlet member and carriage which may be cooperable with one or more stops in, on or secured to the other of the inlet member and carriage and/or may be resiliently biased, e.g. by a spring, toward a holding or connected or latched position or condition. Preferably, the second holding means or connector means is only movable out of the holding or connected or latched position or condition when the inlet member is in the pre-flush position or condition. The inlet member may be releasably connected to the adjustable conduit and/or the adjustable conduit may be releasably connected to the outlet.

Whilst the inlet member may be held in the pre-flush position or condition by the buoyancy member, the second holding means or connector means may be configured to releasably hold the inlet member in a pre-flush position or condition for example with respect to the base or frame.

Additionally or alternatively, the apparatus or base or frame may additionally or alternatively comprise a third holding means or connector means, for example a third catch means, latch means or lock means, e.g. for releasably holding the inlet member in a pre-flush position or condition for example with respect to the base or frame. The third holding means or connector means may comprise one or more movable latches which may be cooperable with one or more stops in, on or secured to the inlet member and/or may be operable by an actuator or push button.

The inlet member may comprise a U-shaped tubular member, e.g. an inverted U-shaped tubular member and/or may comprise an downwardly facing opening which may be enlarged. The adjustable conduit may comprise a flexible portion or bellows. Movement of the inlet member toward the flush position causes the flexible portion or bellows to be compressed.

The actuation means and the partial flush actuation means may be operated using an integrated push button, e.g. wherein a first portion of the button is depressed to actuate partial flush operation and a second portion is depressed to actuate full flush operation.

A second aspect of the invention provides an apparatus comprising any combination of the features described herein.

A third aspect of the invention provides a cistern with an outlet comprising an apparatus as described above, wherein the discharge conduit is sealingly coupled to the outlet.

A further aspect of the invention provides a method of discharging water from a cistern, for example using the draining apparatus described above, the method comprising the steps of decreasing the buoyancy of the or an inlet member to submerge the or an inlet thereof, thereby causing the water to discharge from the inlet through the or a conduit, for example the or an adjustable conduit, and out the or an outlet of the apparatus or cistern.

The method may further comprise increasing the buoyancy of the inlet member to cause it to remain on the surface of the water, e.g. while the cistern is refilled with water.

A yet further aspect of the invention provides a method of flushing a cistern comprising any combination of the steps described herein.

Embodiments of the invention will now be described by way of example only with reference to the accompanying drawings in which:

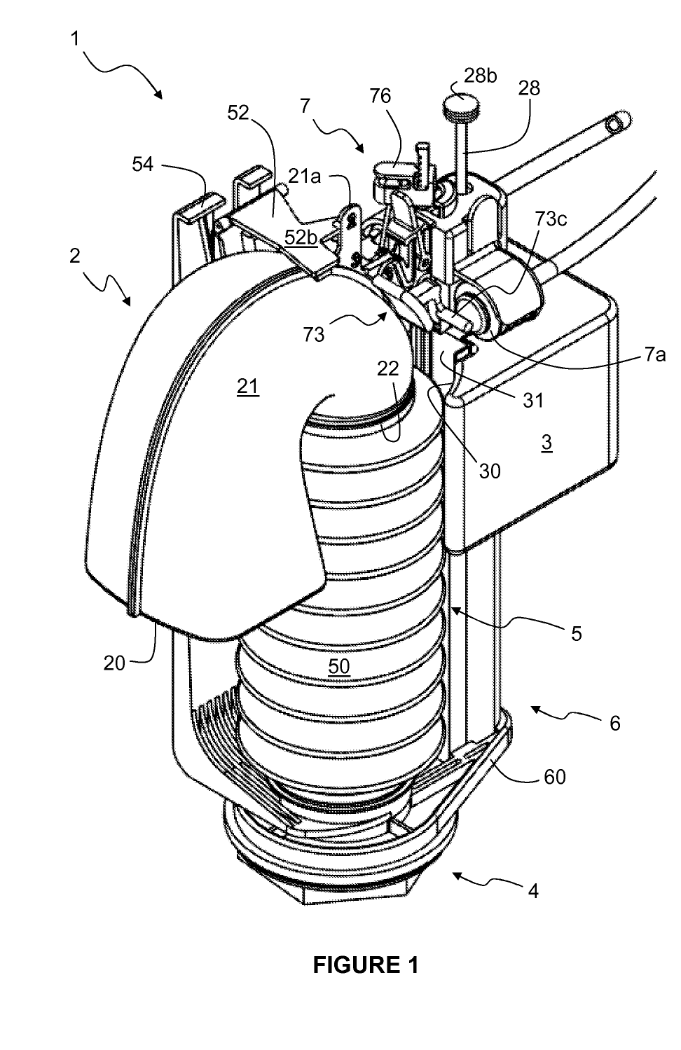

FIG. 1 is a perspective view of a draining apparatus according to one embodiment of the invention;

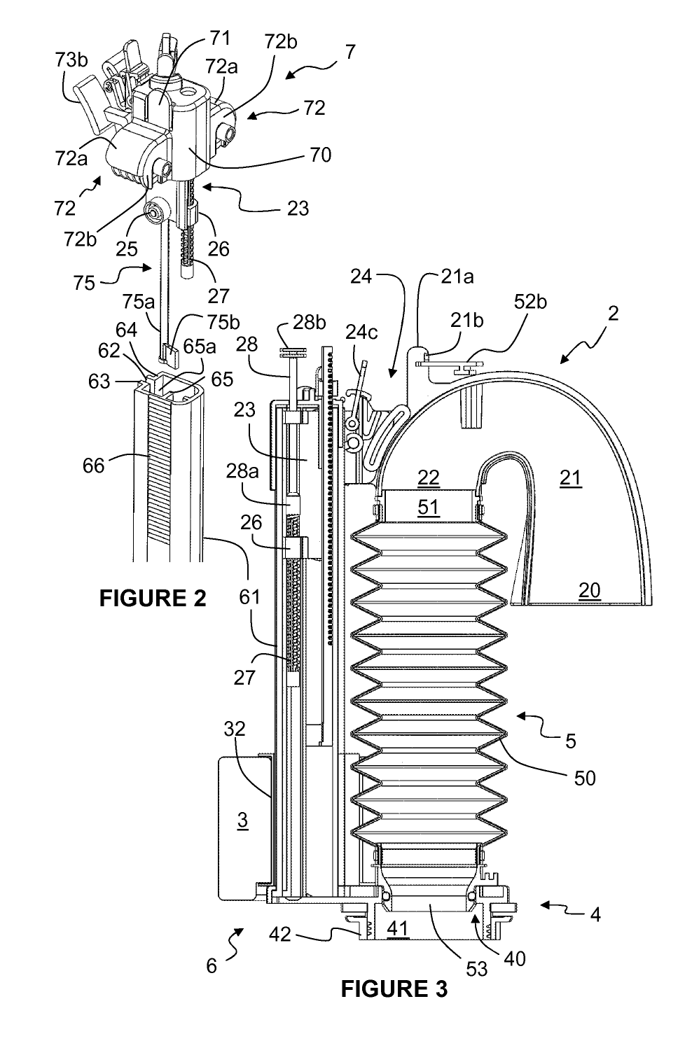

FIG. 2 is a partial exploded view of an upper portion of the upstand;

FIG. 3 is a section view showing the adjustable abutment of the carriage.

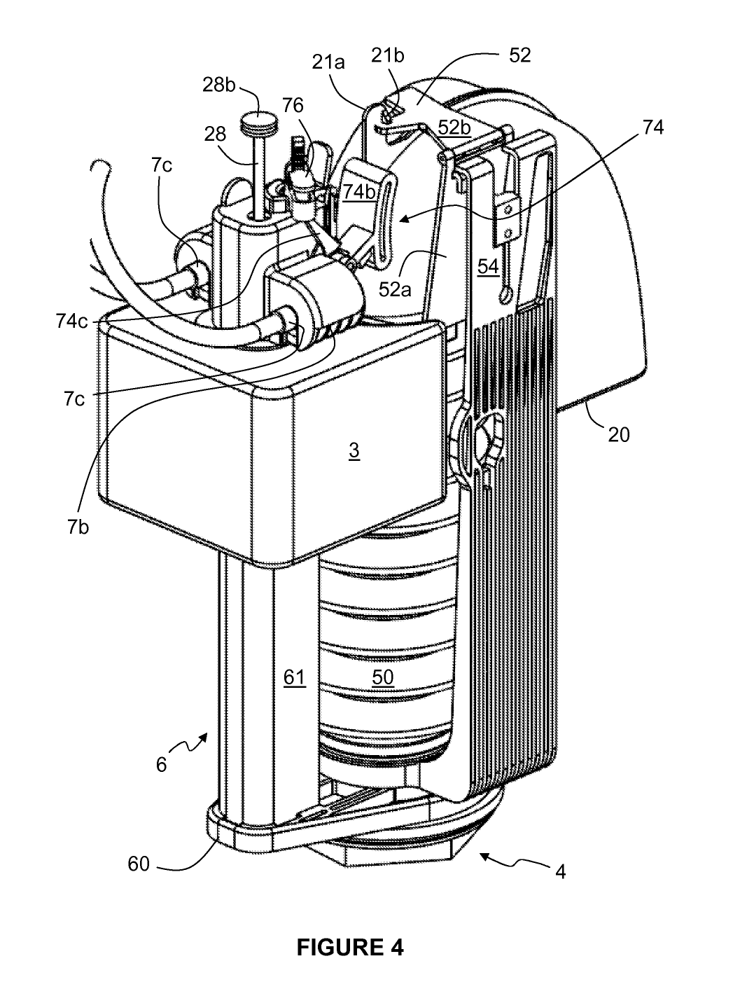

FIG. 4 is a perspective view from the back of the apparatus shown immediately after a partial flush has been initiated;

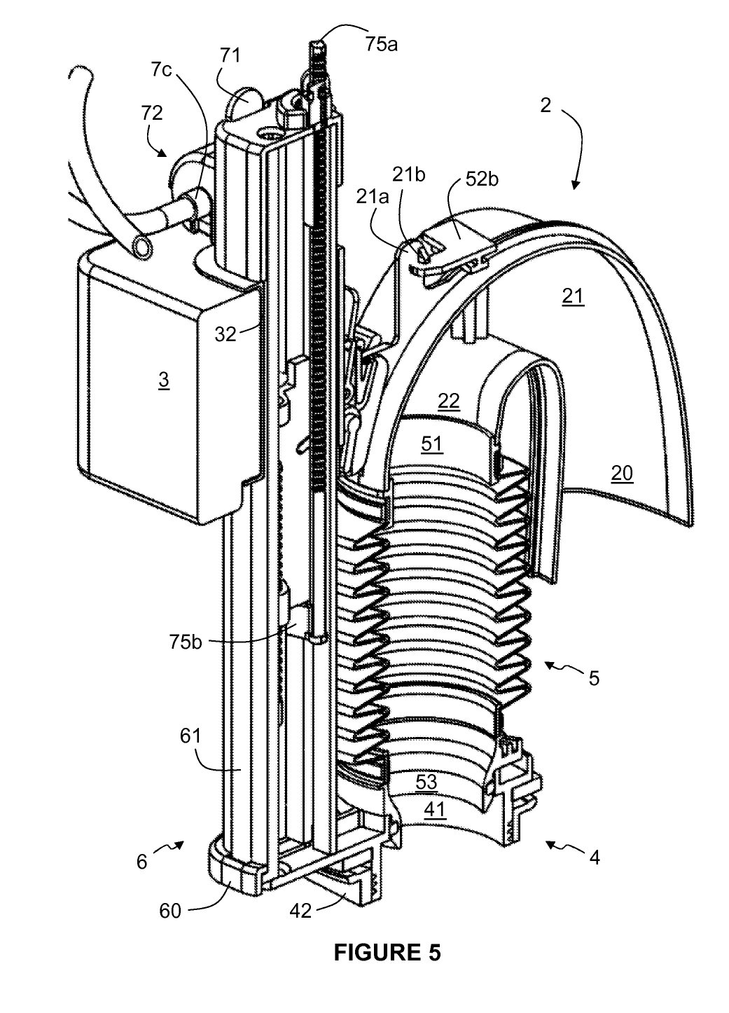

FIG. 5 is a perspective section view of the draining apparatus shown after a partial flush has been initiated with the inlet member in the partial flush position and illustrates the partial flush stop tab in a deployed condition;

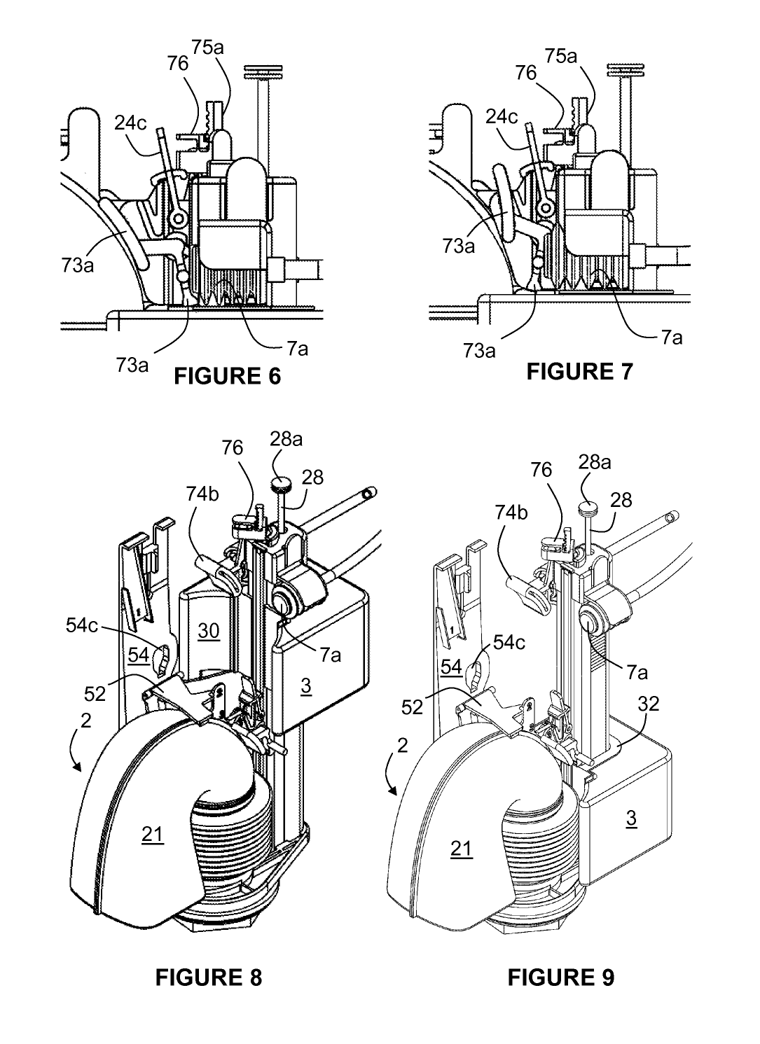

FIGS. 6 and 7 are partial side views of the apparatus of FIG. 1 with the main latch shown in a latched and unlatched condition respectively;

FIG. 8 is a perspective view of the draining apparatus shown after a full flush has been initiated with the inlet member in the flush position;

FIG. 9 is a perspective view of the draining apparatus shown after the full flush has been completed;

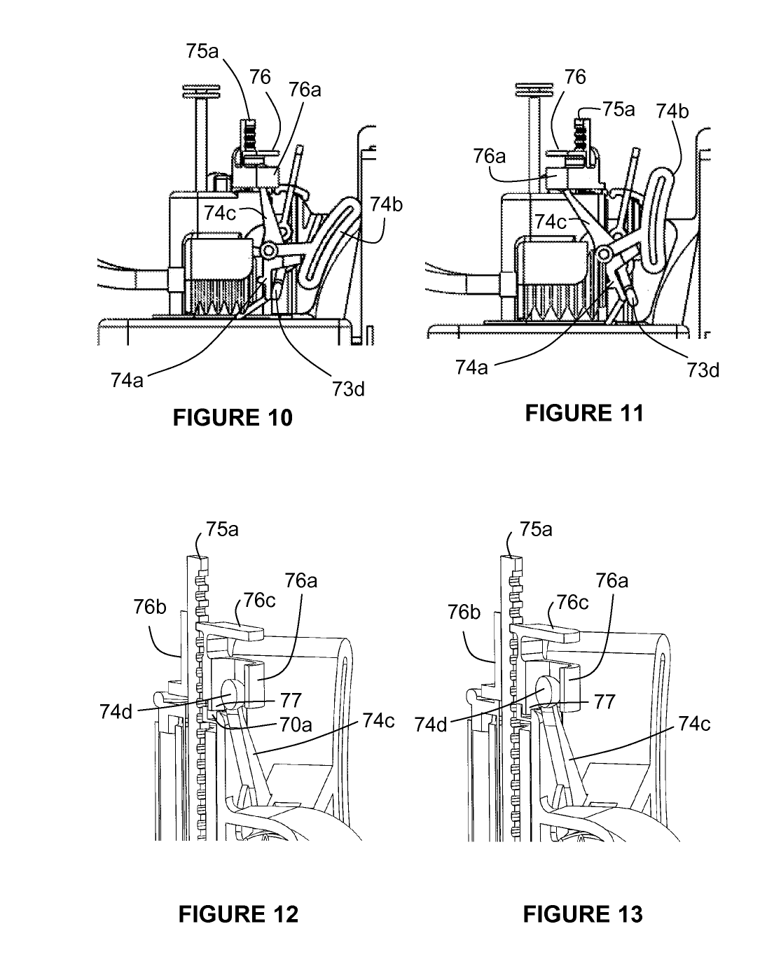

FIGS. 10 and 11 are partial side views of the apparatus with the partial flush lever assembly shown just before and after the partial flush has been initiated respectively;

FIGS. 12 and 13 are partial cutaway perspective views of the apparatus with the pivot member of the partial flush lever assembly shown just before and after it engages the top of the upstand;

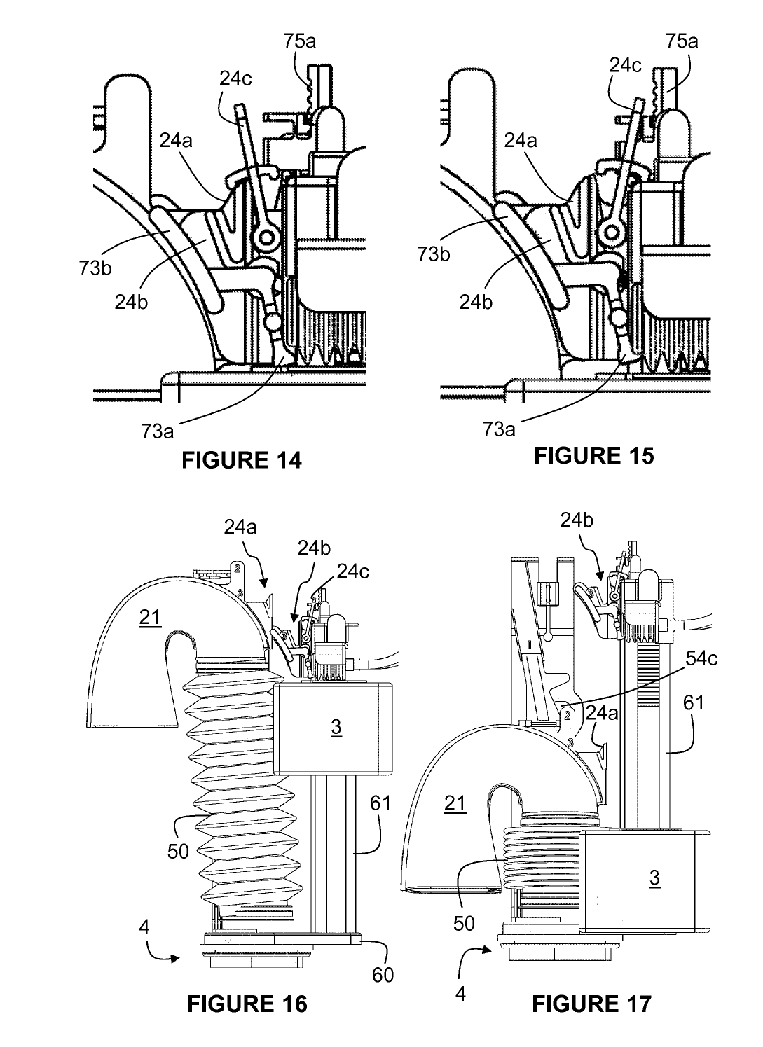

FIGS. 14 and 15 are partial side views of the apparatus with the secondary latch shown in a latched and unlatched condition respectively;

FIGS. 16 and 17 are side views of the apparatus illustrating, respectively, the removal of the inlet member from the carriage and the latching of the main bellows securing tab

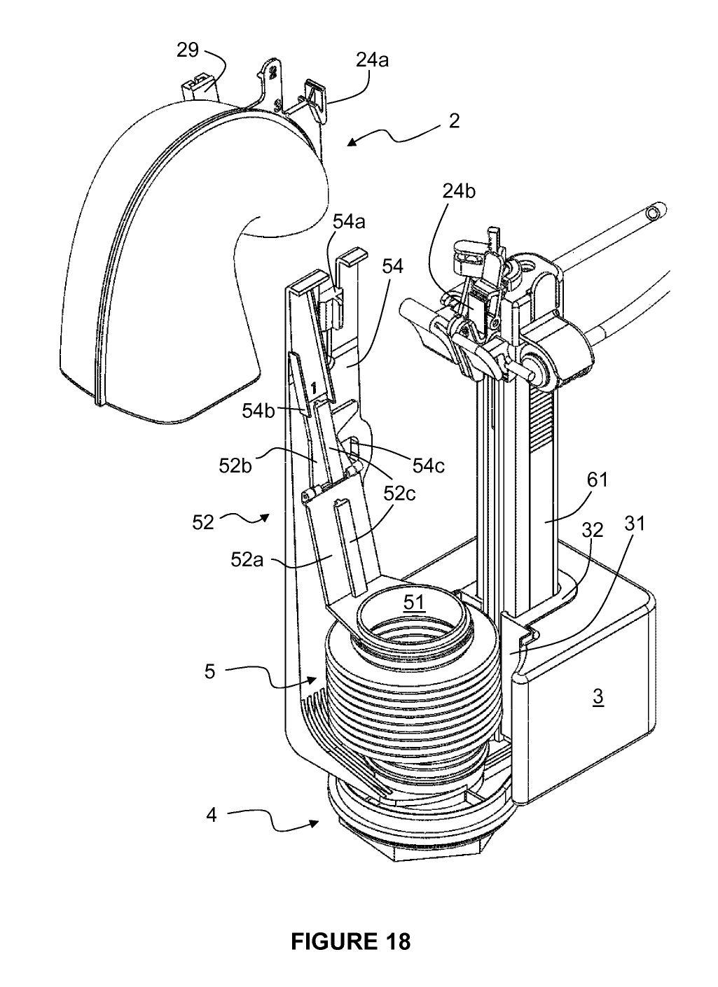

FIG. 18 is a perspective view illustrating the removal of the inlet member;

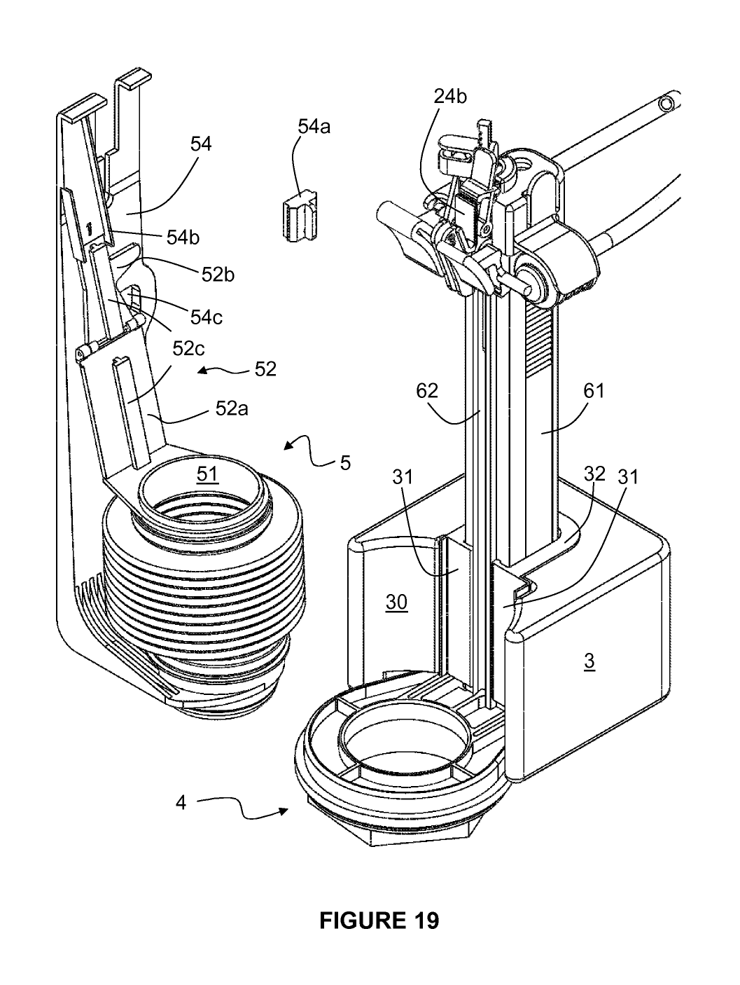

FIG. 19 is a perspective view illustrating the removal of the main bellows;

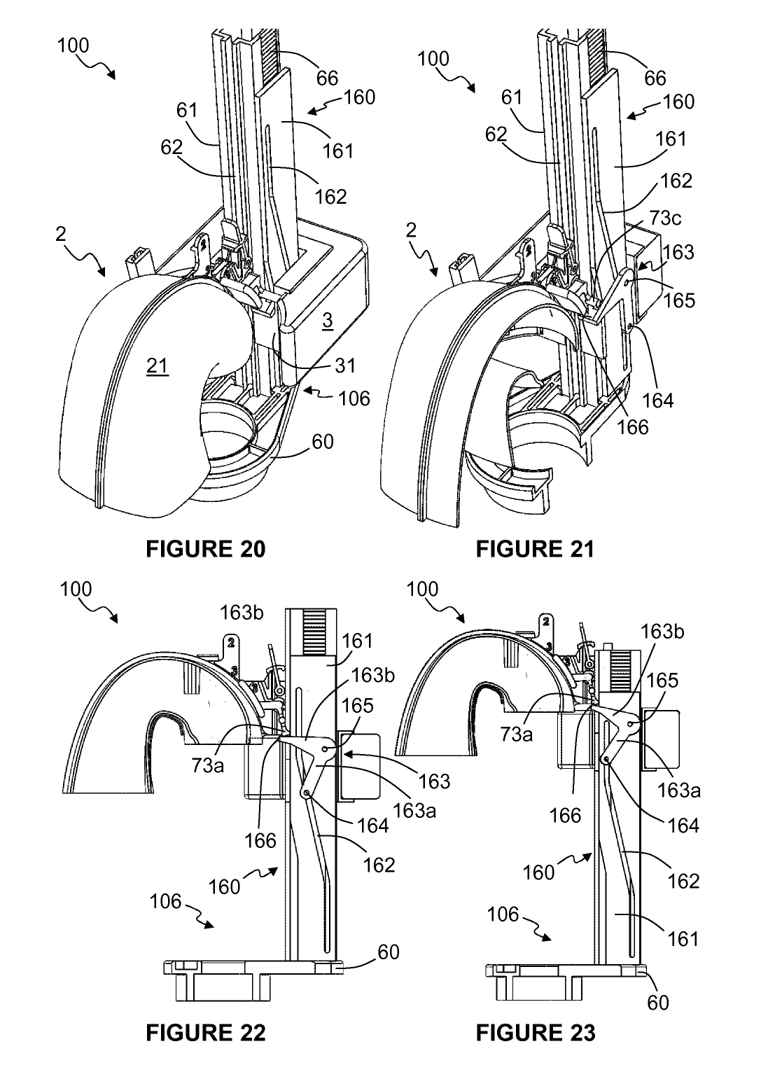

FIGS. 20 to 23 illustrate a draining apparatus according to a second embodiment of the invention with several components omitted for clarity;

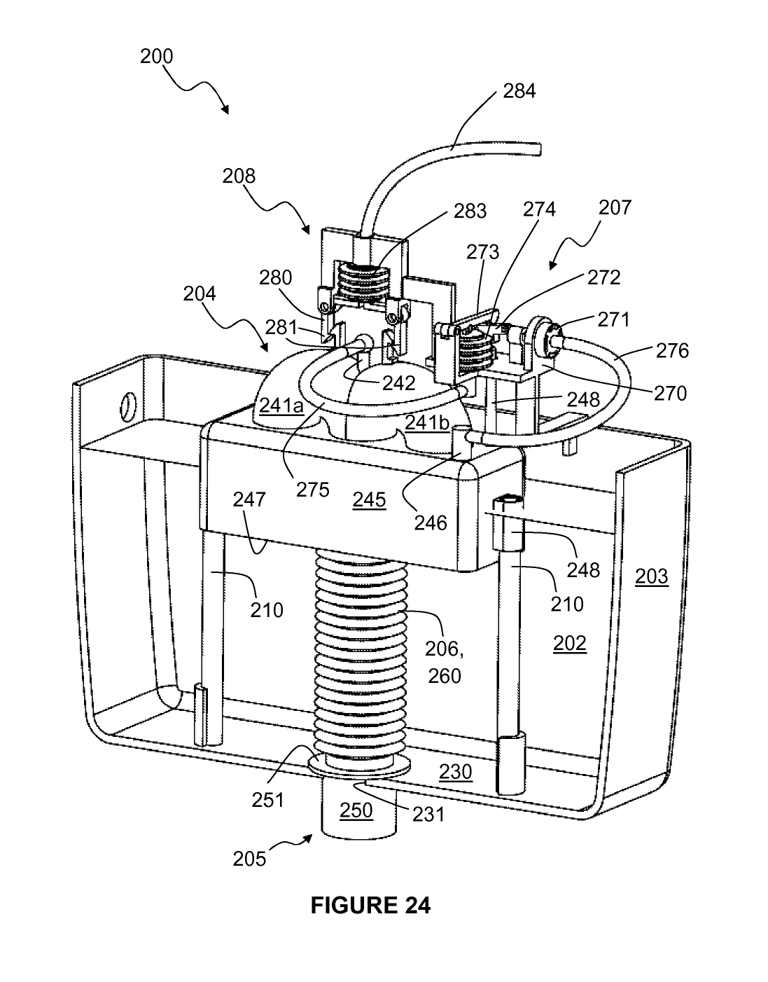

FIGS. 24 to 29 illustrate a draining apparatus according to a third embodiment of the invention; and

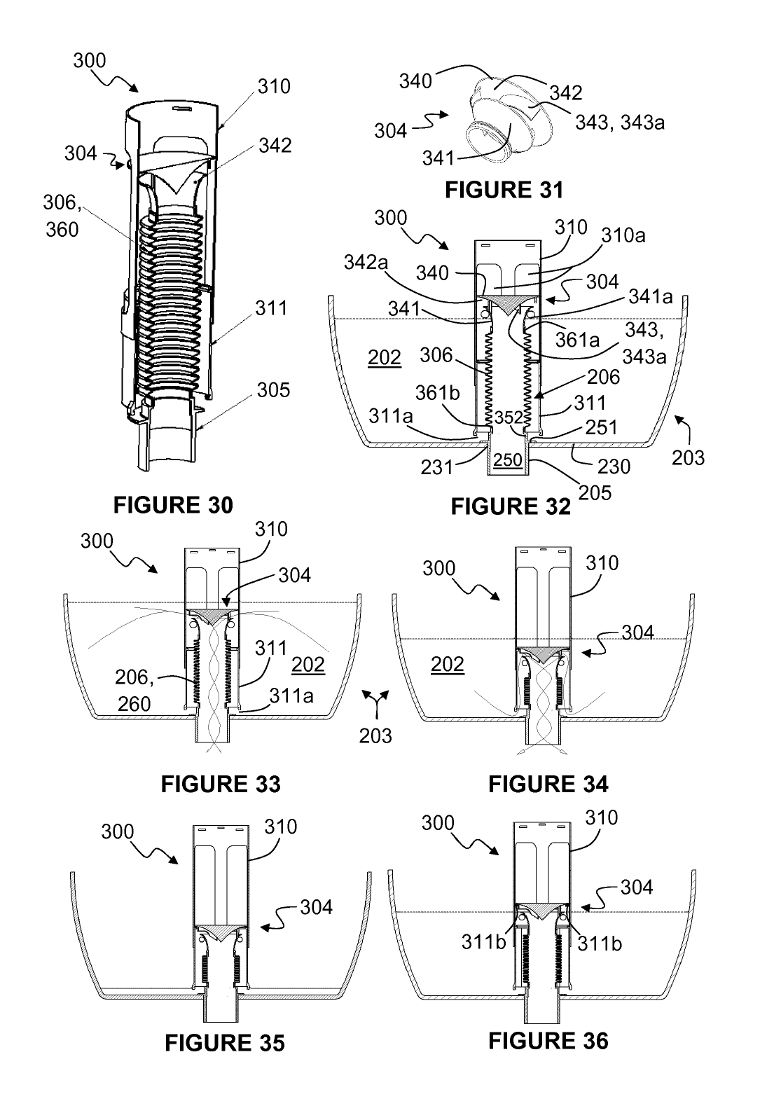

FIGS. 30 to 36 illustrate a draining apparatus according to a fourth embodiment of the invention.

Referring now to FIGS. 1 to 19, there is shown a draining apparatus 1 for discharging water from a cistern (not shown). The apparatus includes an inlet member 2, a buoyancy altering means in the form of a float 3 which is detachably connectable to the inlet member 2, an outlet member 4 fluidly connected to the inlet member 2 by an adjustable conduit 5, an upstand 6 and an activation assembly 7.

The inlet member 2 is in the form of an inverted U-shaped tube 21 with an enlarged substantially rectangular downwardly facing inlet 20 at one of its ends, a downwardly facing outlet 22 at the other of its ends and a generally flat upwardly extending clip 21a with a protrusion 21b extending from one of its major faces. The inlet member 2 includes a carriage 23 which is slideably received within the upstand 6 and to which the tube 21 is connected by a connection part 24 extending from the tube 21 adjacent the outlet 22. The inlet member 2 also includes a securing flange 29 with a T-shaped slot for securing the inlet member 2 to the adjustable conduit 5.

The carriage 23 includes a pair of guide members 25, which are rotatably connected thereto in this embodiment, a flange 26 with an internally threaded hole therethrough which threadedly engages an externally threaded abutment rod 27. The abutment rod 27 includes a square interface head which cooperates with the interface portion 28a of an adjustment tool 28. The adjustment tool 28 can be rotated via its disc shaped handle 28b to adjust the distance by which the abutment rod 27 extends from the bottom of the carriage 23 for adjusting the flush position of the inlet member 2.

The connection part 24 includes first and second connection elements 24a, 24b and a pivotably mounted securing latch 24c for securing the connection elements 24a, 24b together. The first connection element 24a is formed integrally with the inlet member 2 and includes a V-shaped projection which engages a V-shaped recess in the second connection element 24b. As shown more clearly in FIGS. 14 to 17, the securing latch 24c includes a pair of connection arms, one of which is configured to latch the V-shaped projection to retain the first and second connection elements 24a, 24b together and the second of which cooperates with the activation assembly 7 to retain the securing latch 24c in an unlatched condition.

The float 3 is in the form of an expanded polystyrene box and having a generally U-shape in plan with curved ends 30 and a pair of opposed flanges 31 extending inwardly to form a substantially square aperture for receiving the upstand 6. The portion of the float 3 which interacts with the upstand 6 is formed by a liner 32 made of a rigid plastics material, which liner 32 includes the flanges 31.

The outlet member 4 is substantially pear-shaped in plan with its smaller end forming a base 60 of the upstand 6 in this embodiment. The outlet member 4 includes an interface aperture 40 on its top surface and a ring shaped externally threaded spigot portion 41 on its bottom surface with an associated internally threaded fastening ring 42. The spigot portion 41 is arranged to extend, in use, through the outlet of a cistern (not shown) with the fastening ring 42 cooperating therewith to fix the outlet member 4 to the cistern (not shown).

The adjustable conduit 5 includes a bellows 50, an inlet interface ring 51 with a clamp 52 extending therefrom and an outlet interface ring 53 with a clipping adaptor 54 extending upwardly therefrom. The bellows 50 is formed of a flexible but durable elastomeric material such as natural or synthetic rubber. The clamp 52 includes an upwardly extending first clamp part 52a and a second clamp part 52b hinged to the first clamp part 52a and arranged to cooperate with the protrusion 21b of the clip 21a on the tube 21 of the inlet member 2 to lock it into place. The first and second clamp parts 52a, 52b both include a T-shaped protrusion 52c on their inwardly facing surfaces which cooperates with the slot of the securing flange 29 on the inlet member 2. The first clamp part 52a also includes a hook (not shown) on its outwardly facing surface. The clipping adaptor 54 is generally rectangular in shape with a vertically extending slot that cooperates with a clip 54a to secure the adjustable conduit to a side wall of the cistern (not shown). The clipping adaptor 54 also includes a pair of opposed clipping flanges 54b and a hook aperture 54c within which the hook (not shown) of the first clamp part 52a is inserted and engages by clipping the second clamp part 52b between the clipping flanges 54b as a snap fit as shown in FIGS. 17 to 19.

The upstand 6 includes an elongate tubular support member 61 extending upwardly from the base 60 and fixed thereto by a tongue and groove connection (not shown). As shown more clearly in FIG. 2, the support member 61 has a substantially rectangular cross section with a guide slot 62 with reinforcing flanges 63 along the length of one wall 64 of the support member 61, through which guide slot 62 the connection part 24 of the inlet member 2 extends in use. The support member 61 also includes an inwardly extending guide flange 65 along its length which defines a channel 65a between it and the aforementioned wall 64 of the support member 61. The support member 61 also includes saw tooth formations 66 on one of its outer surfaces adjacent its upper end.

The activation assembly 7 includes a cap member 70 which fits over the top of the support member 61 of the upstand 6. The cap member 70 has a hollow body with a securing clip 71 that is resiliently biased to cooperate with the saw tooth formations 66 of the support member 61 and a bellows housing 72 on each of its sides. Each bellows housing 72 includes a curved upper portion 72a extending from the cap member 70, which follows the contour of a bellows 7a, 7b received therein, and a downwardly extending flat base portion 72b with a slot for receiving an inlet spigot 7c of the bellows 7a, 7b. One of the bellows 7a is connected to an actuation means such as a push button (not shown) by a first tube and is configured to activate a full flush. The other bellows 7b is connected to a further actuation means by a second tube, for example a further push button (not shown) and is configured to activate a partial flush, more of which later.

The activation assembly 7 also includes a main latch 73 pivotably mounted to the inlet member 2, a partial flush lever 74 pivotably connected to the cap member 70, a stop member 75 and a pivot member 76. The main latch 73 includes a stop portion 73a for abutting the top of one of the flanges 31 of the float 3, a counter-weight portion 73b for biasing the main latch 73 toward the latched position such that it abuts the top of the flange 31, an actuation portion 73c against which the full flush bellows 7a abuts, in use, to activate a full flush and a link portion 73d for cooperating with the partial flush lever 74. The partial flush lever 74 is formed of two parts 74a, 74c pivotably connected together and including an actuation arm 74a and a pivot lever 74c. The actuation arm 74a has a sloping lower portion and a projection on one of its sides against which the partial flush bellows 7b abuts, in use, to activate a partial flush while its other side abuts the link portion 73d of the main latch 73. The a pivot lever 74c includes an interface ball 74d at one of its ends and a counter-weight portion 74b connected to its other end. The actuation arm 74a includes an abutment (not shown) against which the pivot lever 74c acts to bias the partial flush lever 74 toward its rest position such that it abuts the partial flush bellows 7b.

The stop member 75 includes a toothed shaft 75a with a substantially rectangular cross section and a stop tab 75b extending outwardly from its lower end. The pivot member 76 includes a socket portion 76a within which is received the interface ball 74d of the pivot lever 74c, a sleeve portion 76b which closely matches and within which is received the shaft 75a of the stop member 75. The pivot member 76 also includes a latch 76c which is resiliently biased toward a latched condition in which a portion thereof is received and engaged between adjacent teeth of the shaft 75a and a projection 77 which is received, in use, within a recess 70a of the cap member 70.

In use, the apparatus 1 is in a pre-flush condition as shown in FIGS. 1 and 6. A user activates a full flush cycle by depressing the push button (not shown), which forces air into the full flush bellows 7a. The full flush bellows 7a then pushes the actuation portion 73c of the main latch 73, which causes the main latch 73 to pivot, thereby moving the stop portion 73a away from the flange 31 of the float 3 as shown in FIG. 7. This releases the inlet member 2, which falls under its own weight to the flush position when the abutment rod 27 contacts the base 60 of the upright 6 as shown in FIG. 8, thereby submerging the inlet member 2 such that water enters the inlet 20, passes through the inlet member 2 and the adjustable conduit 5 and out through the outlet member 4, which initiates the syphonic action. The water in the cistern (not shown) continues to flow out of the cistern until the water level reaches that of the inlet 20, at which point the syphon is interrupted.

It will be appreciated that when the inlet member falls clear of the float 3, the counter-weight portion 73a of the main latch 73 causes the main latch 73 to return to the position shown in FIG. 6. It will also be appreciated that the float 3 follows the water level and reaches to the position shown in FIG. 9 when the syphon is interrupted. The underside of the float 3 is shaped such that the actuation portion 73c of the main latch 73 is urged toward the condition shown in FIG. 7 until the flanges 31 thereof fall clear of the stop portion 73a of the main latch 73, at which point the main latch 73 returns to the condition shown in FIG. 6. The cistern (not shown) is then refilled in the normal way such that the float 3 is caused to return to the position shown in FIG. 1, carrying the inlet member 2 with it.

A user may also activate the partial flush cycle by depressing a further push button (not shown), which forces air into the partial flush bellows 7b. The partial flush bellows 7b then pushes the actuation arm 74a of the partial flush lever 74, which causes the partial flush lever 74 to pivot as shown more clearly in FIGS. 10 to 13. This movement causes the link portion 73d to move the stop portion 73a of the main latch 73 away from the flange 31 of the float 3 as described above in relation to a full flush cycle. However, the movement of the partial flush lever 74 simultaneously causes the interface ball 74d of the pivot lever 74c to force the pivot member 76 to pivot, thereby rotating the stop member 75 to a partial flush condition in which the stop tab 75b is deployed as shown in FIG. 5. As the pivot member 76 is rotated, the pivot member projection 77 falls under the influence of gravity into the recess 70a of the cap member 70. This prevents counter rotation of the pivot member 76. When the further push button (not shown) is released, the partial flush bellows 7b is deflated and the actuation arm 74a then drops to its rest position. It will be appreciated that the sloped lower portion of the actuation arm 74a ensures that the link portion 73d of the main latch 73 always returns to the correct side of the actuation arm 74a even if a user depresses the further push button (not shown) while the cistern is still in the process of being refilled.

Thus, the inlet member 2 falls under its own weight to a partial flush position as shown in FIG. 5 by virtue of the carriage 23 contacting the stop tab 75b. The water level at which the syphonic action is interrupted is therefore higher than in the full flush cycle. However, the inlet member 2 is reconnected to the float 3 as described above and is returned to the pre-flush position shown in FIG. 1 in a similar fashion.

It will be appreciated that the full flush position is adjustable by virtue of the threaded abutment rod 27, whose lower abutment surface may be moved relative to the to the carriage 23 using the aforementioned adjustment tool 28. It will also be appreciated that the partial flush position may be adjusted by depressing the pivot member latch 76c, thereby releasing it from between the teeth of the shaft 75a, sliding the shaft up or down such that the stop tab 75b is at the desired position and releasing the latch 76c such that it engages the shaft 75a between a different pair of teeth.

The apparatus 1 according to this embodiment is also configured to be installed into an existing cistern and to be serviced with ease. More specifically, the adjustable conduit 5, which is believed to be a wear component, may be removed as follows with reference to FIGS. 14 to 19.

In its normal condition, the securing latch 24c of the connection part 24 is in the condition shown in FIG. 14. The flush valve (not shown) is closed off to prevent the cistern (not shown) from refilling. In order to remove the adjustable conduit 5, the securing latch 24c is pivoted out of engagement with the first connection element 24a and into engagement with the cap member 70 as shown in FIG. 15. The inlet member 2 is then lifted such that the V-shaped projection of the first connection element 24a is removed from the V-shaped recess of the second connection element 24b as shown in FIG. 16. The inlet member 2 is then released such that it falls to its full flush position as shown in FIG. 17 and the water in the cistern is thereby evacuated. In order to secure the first clamp part 52a to the clipping adaptor 54, the hook (not shown) of the first clamp part 52a is inserted into the aperture 54c and lowered such that it engages a lower portion of the aperture 54c and the second clamp part 52b is then snapped away from the protrusion 21b of the inlet member clip 21a, pivoted away therefrom and snap fitted in between the clipping flanges 54b of the clipping adaptor 54.

The inlet member 2 is then free to be removed as shown in FIG. 18 by sliding the securing flange 29 thereof along the T-shaped protrusion 52c of the clamp 52. The clip 54a of the clipping adaptor 54 is then released from the cistern wall (not shown) and the adjustable conduit 5 is removed as shown in FIG. 19. Similarly, the or a new adjustable conduit 5 and the inlet member 2 can be replaced by carrying out the above steps in reverse.

FIGS. 20 to 23 illustrate part of a draining apparatus 100 according to a second embodiment which is similar to the first embodiment, wherein like references depict like features, but for the addition of a lifting mechanism 160 for raising the inlet member 2 relative to the float 3 as the float rises in use. The lifting mechanism 160 includes an elongate rectangular guide plate 161 with a guide slot 162 and a lift lever 163. The guide plate 161 is secured to and runs along the length of one side of the support member 106. The guide slot 162 includes upper and lower straight sections which run longitudinally of the guide plate 161 adjacent the front and rear thereof respectively, which upper and lower sections are interconnected by a sloped intermediate section. The lift lever 163 is substantially L-shaped in plan with first and second legs 163a, 163b and is pivotably connected to the float 3 by a pivot pin 165 at the intersection of the legs 163a, 163b. The first leg 163a includes a free end with a guide pin 164 that extends laterally therefrom and slideably engages the guide slot 162. The second leg 163b includes a free end with a foot portion 166 extending laterally therefrom which engages the stop portion 73a of the main latch 73 in use. Thus, as shown in sequence in FIGS. 21 to 23, movement of the float 3 along the support member 61 causes the inlet member 2 to be raised relative to the float 3 since the lift lever 163 tilts as the guide pin 164 travels along the sloped intermediate section of the guide slot 162.

Referring now to FIGS. 24 to 29, there is shown a draining apparatus 200 according to a second embodiment which is similar to the first embodiment, wherein like references depict like features. The apparatus has an inlet member 204, a discharge conduit 205 which is fluidly connected to the inlet member 204 by an adjustable conduit 206, a pair of guide posts 210 on either side of the adjustable conduit 206 which extend in a direction parallel thereto, a buoyancy control valve assembly 207 and a catch means 208. The cistern 203 in this embodiment is a conventional tank for a toilet as is known in the art, with a base wall 230 and having an outlet 231 therein.

The inlet member 204 includes a straight cylindrical portion 240 the top of which extends into opposed twin U-shaped bend portions 241a, 241b to form an overall M-shaped tubular cross section. A vacuum port 242 is located at the junction between the U-shaped bend portions 241a, 241b. The base of the cylindrical portion 240 includes an outlet 243 and each of the free ends of the U-shaped bend portions 241a, 241b includes a respective inlet 244a, 244b.

The inlet member 204 also includes a rectangular box-shaped buoyancy chamber 245 with an evacuation outlet 246, an open bottom 247 which forms an inlet 247 thereof and a pair of guides 248 for receiving the guide posts 210. The buoyancy chamber 245 surrounds and is sealingly connected to the cylindrical portion 240 and a lower straight section of each of the U-shaped bend portions 241a, 241b. The inlet 247 of the buoyancy chamber is adjacent but slightly higher than the inlets 244a, 244b of the twin U-shaped bend portions 241a, 241b. The inlet member also includes an elongate plunger 248 which extends upwardly from the buoyancy chamber 245.

The adjustable conduit 206 is in the form of a pleated or corrugated tube 260, namely a bellows 260, is made of rubber latex in this embodiment. The base of the cylindrical portion 240 of the inlet member 204 is sealingly connected to an upper end of the bellows 260, while a lower end of the bellows 260 is sealingly connected to an upper end of the discharge conduit 205. The discharge conduit 205 includes a tubular wall 250 with an outwardly extending ring shaped flange 251 adjacent its upper end. The discharge conduit 205 is received within the outlet 231 of the cistern 203 such that the flange 251 abuts and sealingly engages the base wall 230 using conventional sealing means (not shown). The guide posts 210 are elongate and generally cylindrical in shape and are slidably received by the guides 248 of the inlet member 204. The guide posts 210 extend from and are fixed to the base wall 230 of the cistern. The apparatus 200 also includes a retractable stop 211 which abuts each guide post 210 in use and is deployed by the control unit (not shown) when a partial flush is requested.

The buoyancy control valve assembly 207 includes a frame 270, a diaphragm valve 271 mounted to the frame, a primary lever 272 pivotably connected to the frame 270, a secondary lever 273 pivotably connected to the frame 270 and a vacuum bellows 274. The vacuum bellows 274 is fluidly connected to the vacuum inlet 242 by a vacuum tube 275 and is compressed by a partial vacuum generated by the siphonic effect created within the inlet member 204 during the flush cycle. The valve 271 is fluidly connected to the evacuation outlet 246 by an evacuation tube 276 for selectively allowing or preventing evacuation of the air within the buoyancy chamber 245.

Downward motion of the main lever 272 urges the valve 271 into a closed position and upward motion thereof releases the valve 271, thus allowing it to return to an open position. The vacuum bellows 274 is connected to the secondary lever 273 at a position spaced from its fulcrum such that compression of the vacuum bellows 274 urges the secondary lever 273 downwardly, thereby urging the main lever 272 downwardly and closing the valve 271. The main lever 272 is urged upwardly by the plunger 248 of the inlet member 204, thereby opening the valve 271, when the inlet member 204 is in the pre-flushing position shown in FIG. 24.

The catch means 208 includes a pair of opposed L-shaped latches 280 with inwardly facing catch portions 281, each of which engages a correspondingly shaped grab member 282 which extends from the top of the inlet member 204. The latches 280 are pivotably mounted at the corner of the L-shape to the frame 270 such that together they form a substantially inverted U-shape. A catch bellows 283 is mounted directly above the opposed ends of the latches 280 such that the catch portions 281 pivot away from each other when the catch bellows 283 is energised. The catch bellows 283 is fed by a pneumatic actuation line 284 which is energised by a push button (not shown) in this embodiment.

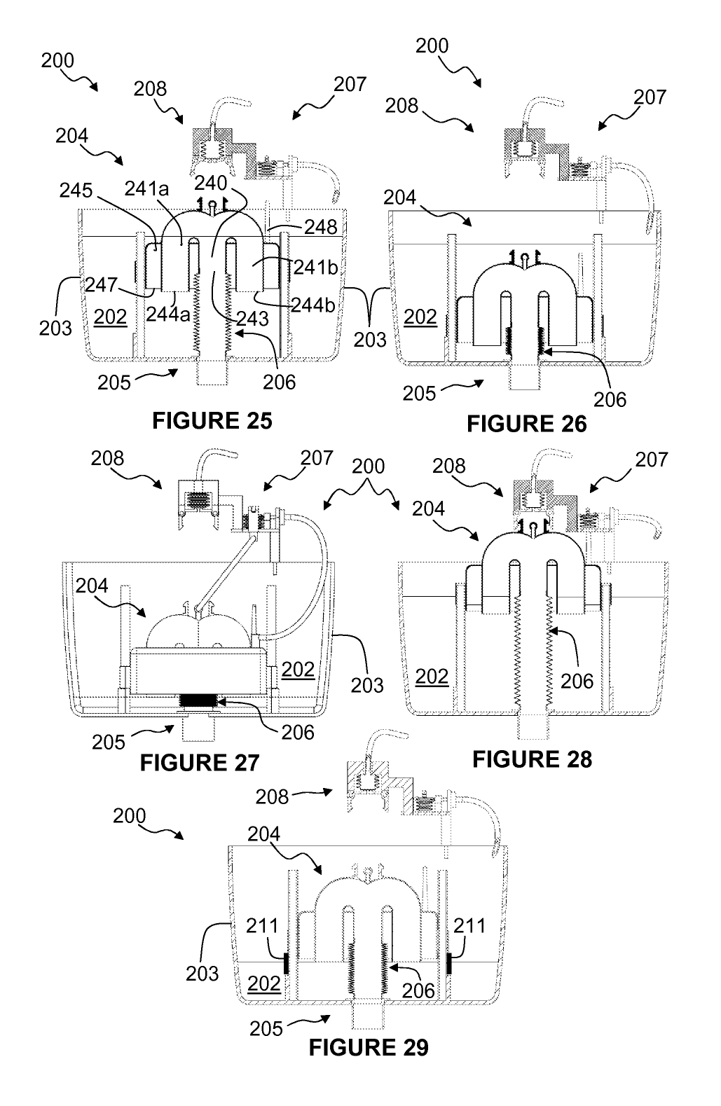

In use, the inlet member 204 is in the pre-flushing position shown in FIG. 24 and operation of the apparatus is initiated by pressing the push button (not shown). Actuation of the push button energises the catch bellows 283, thus urging the opposed catch portions 281 of the latches 280 apart and releasing the grab members 282 as shown in FIG. 25. Since the valve 271 is open, the air in the buoyancy chamber 245 is free to be evacuated therefrom and the weight of the inlet member 204 therefore causes it to sink. Water 202 enters the twin U-shaped bend portions 241a, 241b and is diverted into the cylindrical portion 240, down the bellows 260, out through the discharge conduit 205 and into a toilet bowl (not shown). This generates a siphonic action, creating a partial vacuum in an upper portion of the twin U-shaped bend portions 241a, 241b, which is transferred through the vacuum tube 275 to the vacuum bellows 274, which closes the valve 271 as described above.

The inlet member 204 either continues to the full flush position shown in FIGS. 26 and 27 or to a partial flush position as shown in FIG. 29 depending on whether the stops 211 have been deployed. As the water level passes the inlet 247 of the buoyancy chamber 245, the water contained therein is evacuated and, when the water level reaches that of the inlets 244a, 244b of the U-shaped bend portions 241a, 241b (shown in FIG. 27), the siphonic action is interrupted.

As in the normal operation of cistern flushing apparatus, the water level in the cistern 203 then begins to rise as the contents are refilled. As the valve 271 is closed, the air in the buoyancy chamber 245 is trapped therein, thus causing the inlet member 204 to become buoyant and to rise together with the water level. As the inlet member 204 approaches the upper end of its travel, the grab members 282 force the latches 280 apart until they snap back into the position shown in FIG. 28. Further movement of the inlet member causes the plunger 248 to open the valve 271 as described above, thereby releasing the pressure within the buoyancy chamber 245 and causing it to drop down to the point at which the latches 280 engage the grab members 282. The cycle is then repeated as required.

Referring now to FIGS. 30 to 36, there is shown a draining apparatus 300 according to a second embodiment which is similar to the first embodiment, wherein like references depict like features. The apparatus 300 in this embodiment has a cone shaped inlet member 304 and a guide cage 310 surrounding the adjustable conduit 206, the base of the guide cage 310 being connected to a siphoning member 311. The inlet member 304 includes a substantially cone-shaped upper portion 340 and a tubular lower portion 341 which follows the contour of the cone shape of the upper portion 340 but is offset therefrom to provide a channel 342 therebetween with an inlet 342a. The shape of the resulting channels 342 provides a smooth transition for the flow of water 202 to change direction. The inlet member 304 also includes flow altering means 343, which is a vortex inducing means 343 in this embodiment, in the form of three directional vanes 343a. The vanes 343a are curved and interconnect opposing surfaces of the upper and lower portions 340, 341 to divide the channel 342 into three curved flow paths through which water 202 passes in use. A tubular buoyancy member 341a is connected to the lower portion 341 of the inlet member 304.

The guide cage 310 is made of polyvinylchloride, is generally cylindrical in shape and slidably receives the peripheral edge of the inlet member 304. The guide cage 310 includes vertically extending apertures 310a which allow water 202 to pass therethrough and into the inlet 342a in use. The siphoning member 11 is made of polyvinylchloride, is cylindrical in shape and is connected (not shown in Figures) at its base to the flange 251 of the discharge conduit 205 via interlocking details (not shown) moulded into the two components 311, 251. The interlocking details (not shown) are in the form a of a bayonet arrangement and maintain the vertical position of the two components 310, 311. The siphoning member 311 is located concentrically with the guide cage 310 and is connected to a lower portion thereof at its upper end. The lower edge of the cylindrical siphoning member 311 is offset from the base 230 of the cistern 203 to provide a gap 311a.

The inlet member 304 is operatively connected to a push button mechanism (not shown) which is arranged to urge the inlet member 304 downwardly to submerge it in the water 202.

In use, the push button mechanism (not shown) is actuated and the inlet member 304 is submerged. Water then passes through the inlet 342a and between the vanes 343, down the bellows 260 and out through the discharge conduit 205. The discharge conduit 205 is open to atmospheric pressure at its lower end 253 and therefore provides no resistance to the flow of water 202. The vanes 343 direct the flow of water 202 to form a spiral or helical shaped flow, e.g. a flow vortex, as shown in FIGS. 33 and 34. This flow vortex exerts a downward force on the inlet member 304, which causes the bellows 260 to compress until the inlet member 304 abuts and sealingly engages the upper edge 311a of the siphoning member at the flush position as shown in FIG. 34. It will be appreciated that this arrangement only requires the push button mechanism (not shown) to provide sufficient force and displacement to submerge the inlet member 304 enough to initiate the flow vortex. The flow vortex then provides sufficient downward or sinking force to counter the buoyancy member 341a and urge the inlet member 304 to the flushing position shown in FIG. 34. It will be appreciated that the cage 310 guides the downward movement of the inlet member 304.

In the flushing position, the inlet member 304 abuts and sealingly engages the upper edge of the siphoning member 311. This sealed engagement prevents the flow of water directly into the inlet 342a, but creates a siphoning action by drawing water under the gap 311a, into the inlet 342a and out through the discharge conduit 205. The water 202 continues to flow under the gap 311a, through the inlet 342a, down the bellows 260 and out of the discharge conduit 205 until the water level within the cistern 203 reaches the top of the gap 311a, at which point the siphoning action is interrupted or broken.

The cistern 303 is then refilled with water 202 in the normal way and the inlet member 304 rises with the water level by virtue of the buoyancy member 341a until it returns to the position shown in FIG. 32. The apparatus 300 is then ready for a further flushing cycle as described above.

An optional feature of the first embodiment of the invention is shown in FIG. 36, wherein the flushing position corresponds to a partial flushing position when movable stops 311b are deployed. When the stops 311b are retracted, the flushing position corresponds to a full flushing position as shown in FIGS. 34 and 35. The stops 311b are located above the upper edge of the siphoning member 311 to prevent the inlet member 304 from sealing engaging it when they are deployed, thus preventing the siphoning action described above. The water 202 therefore ceases to discharge when the water level reaches the inlet 342a, as shown in FIG. 36, and the buoyancy member 341a urges the inlet member 304 above the surface of the water.

It will be appreciated by those skilled in the art that several variations to the embodiment disclosed herein are envisaged without departing from the scope of the invention. For example, the buoyancy altering means may comprise a buoyancy control means wherein the buoyancy of the inlet member 2 may be controllably modified. The buoyancy control means may include a buoyancy chamber, for example connected to the inlet member 2, and/or a valve which is preferably operable between an open condition for releasing air from the chamber and/or a closed condition for retaining air within the chamber. Additionally or alternatively, the buoyancy altering means may comprise vortex inducing means and/or flow altering vanes at or adjacent the inlet, which may be arranged to alter, in use, the flow of water, e.g. the direction and/or flow rate of the water, passing through the inlet thereby to reduce the effective buoyancy of the inlet member. The main latch 73 may be replaced with any form of holding means or connector means, for example a catch means or lock means, which is operable to connect or secure the float 3 to or hold the float 3 with the inlet member 2 and to disconnect or release the float 3 therefrom. The guide members 25 may be fixed to the carriage and need not be rotatable, e.g. they could function as guide bushes. The guide plate 161 may be formed integrally with the support member 106 and/or the guide slot 162 and/or lift lever 163 may be replaced with any suitable arrangement which is able to perform the required function.

The inlet member 204 and/or the buoyancy chamber 245 may take any shape or configuration, provided they are able to function in the required manner. Also, the needle valve 271 may be replaced with any type of valve or any suitable means for controlling the buoyancy of the inlet member 204. The operation of the valve 271 may be varied or its actuation may be achieved through any number of means. The catch arrangement 208 described herein may be replaced with any suitable arrangement, for example it may comprise a stop member or an electromagnetic retaining means or any other suitable arrangement.

Moreover, the guide means may be located within the adjustable conduit, for example in the form of a telescopic arrangement. The push button may be replaced with any suitable actuation means. It is further envisaged that the pneumatic control arrangement described may be replaced with, for example, an electro-mechanical assembly or any other suitable arrangement. The apparatus need not have stops 211 and/or may comprise any other suitable means of causing a partial flush and need not even be configured for dual flush operation.

It will also be appreciated by those skilled in the art that any number of combinations of the aforementioned features and/or those shown in the appended drawings provide clear advantages over the prior art and are therefore within the scope of the invention described herein.

1. A draining apparatus for discharging water from a cistern, said apparatus comprising an inlet member, a buoyancy member held with said inlet member by holding means and an outlet fluidly connected to an inlet of said inlet member by an adjustable conduit, wherein said holding means is operable to release said buoyancy member from said inlet member to decrease the buoyancy of said inlet member thereby submerging, in use, at least a portion of said inlet and discharging water from said cistern.

2. Apparatus according to claim 1, wherein said holding means is operable to reconnect, in use, the buoyancy member to the inlet member when the water reaches a predetermined level in the cistern.

3. (canceled)

4. (canceled)

5. Apparatus according to claim 1, wherein said holding means comprises a catch, latch or lock.

6. Apparatus according to claim 1 further comprising a flush actuator configured to operate said holding means being biased toward a holding or latched or locked state.

7. (canceled)

8. (canceled)

9. Apparatus according to claim 1, wherein said inlet member is slideably connected to an upstand and movable between a pre-flush position and a flush position.

10. Apparatus according to claim 9, wherein said inlet member is connected to a carriage which is slideably received within said upstand.

11. Apparatus according to claim 1 further comprising an adjustable abutment for adjusting the flush position.

12. (canceled)

13. Apparatus according to claim 10 further comprising a stop movable between a retracted position to allow said inlet member to move, in use, to a full flush position and a deployed position in which said stop stops said inlet member at an intermediate or partial flush position.

14. Apparatus according to claim 13, wherein said stop is at least partially located within said upstand to cooperate with said carriage.

15. Apparatus according to claim 13, wherein said stop is connected to a rotatable shaft which rotatably moves said stop between said retracted position or condition.

16. Apparatus according to claim 15 further comprising a partial flush actuator configured to move a first end of a lever which is connected at its second end to a pivot member extending from and/or connected to said shaft, thereby rotating said stop between said retracted and deployed positions said partial flush actuator being configured to cause said holding means to disconnect or release said buoyancy member from said inlet member when said stop is operated from said retracted position to said deployed position.

17. (canceled)

18. (canceled)

19. Apparatus according to claim 13, wherein said stop is adjustable to adjust the intermediate or partial flush position.

20. Apparatus according to claim 10, wherein said inlet member is releasably connected to said carriage.

21. Apparatus according to claim 1, wherein said inlet member is releasably connected to said adjustable conduit.

22. Apparatus according to claim 1, wherein said adjustable conduit is releasably connected to said outlet.

23. (canceled)

24. (canceled)

25. (canceled)

26. (canceled)

27. (canceled)

28. (canceled)

29. A kit of parts for assembly into an apparatus according to claim 1.

30. A cistern comprising an outlet and an apparatus according to claim 1, wherein said discharge conduit is sealingly coupled to said outlet.

31. A draining apparatus for discharging water from a cistern, said apparatus comprising an inlet member, an outlet fluidly connected to an inlet of said inlet member by an adjustable conduit, a buoyancy chamber connected to said inlet member and a valve operable between a closed condition for retaining air within said chamber and an open condition for releasing air from said chamber to decrease said buoyancy of said inlet member thereby submerging, in use, at least a portion of said inlet and discharging water from said cistern.

32. A draining apparatus for discharging water from a cistern, said apparatus comprising an inlet member, buoyancy altering means connected to said inlet member and an outlet fluidly connected to an inlet of said inlet member by an adjustable conduit, wherein said buoyancy altering means comprises a vortex inducing means at or adjacent said inlet arranged to alter, in use, the direction and/or flow rate of the water passing through said inlet thereby to reduce said effective buoyancy of said inlet member and submerge, in use, at least a portion of said inlet and discharge water from said cistern.

33. Apparatus according to claim 32, wherein said buoyancy altering means comprises flow altering vanes at or adjacent said inlet arranged to alter, in use, the direction and/or flow rate of the water passing through said inlet thereby to reduce the effective buoyancy of said inlet member.
